(19) United States
(12) Patent Application Publication
(10) Pub. No.: US 2005/0262441 A1
(43) Pub. Date: Nov. 24, 2005

(54) Method and apparatus for printing web pages

(75) Inventor: Jun-ho Yoon, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/132,266

(22) Filed: May 19, 2005

(30) Foreign Application Priority Data
May 21, 2004 (KR) 10-2004-0036484

(51) Int. Cl. G06F 17/21

(52) U.S. Cl. 715/526; 715/517

(57) ABSTRACT

A web page print method and apparatus is provided for adjusting the size of a web page for printout. The method for printing web pages comprises the steps of inputting a print command with respect to a certain web page, comparing a size of the web page to that of the paper, reducing text and images contained in the web page by a predetermined unit, respectively, if the size of the web page is larger than that of the paper, and generating data for printout with respect to the web page containing the reduced text and images and printing the data on the paper. Accordingly, the method and apparatus prevents the content of the web page from being truncated off the paper when printed.

### CROSS-REFERENCE TO RELATED APPLICATIONS

This application claims the benefit under 35 U.S.C. § 119(a) of Korean Patent Application No. 10-2004-0036484 filed in the Korean Intellectual Property Office on May 21, 2004, the entire disclosure of which is incorporated herein by reference.

### BACKGROUND OF THE INVENTION

1. Field of the Invention

The present invention relates to a method for printing web pages. More particularly, the present invention relates to a method for printing web pages that is capable of adjusting the printout of the content of a web page to fit a paper size so as to prevent the content of the web page from being truncated off the paper when printed.

2. Description of the Related Art

In recent years, the internet has been used more and more by users who search for desired information by using web browsers such as Internet Explorer and Netscape. In doing so, a user displays search results on a computer screen, checks web pages obtained by the browser through such internet searches, and, if necessary, prints the content of the web pages by using a printer.

However, most web pages are created for display on a display screen, such as an LCD or CRT display, so that the text font sizes and image sizes contained in the contents of the web pages are usually set in consideration of the display layout and the size of the screen.

Thus, in most cases, the layout of the contents of the web pages does not match the size of the paper used for printout. In particular, if a web page is printed on paper in the case wherein the size of the web page is larger than that of the paper, the entire web page is not printed on the paper and a part of the web page is truncated.

Recently, however, some web sites separately provide a print version of their web pages in order to solve the above problems, which offers a greater degree of convenience to their visitors.

FIG. 1 is a view for showing such a conventional web page as an example. In FIG. 1, there is a location 1 marked ‘printable version’ on the lower left side of the web page. That is, the content of the web page can be provided in a printable version that is laid out to fit the size of the paper, and has a hypertext link at a location 1 marked ‘printable version’. A user can click on the printable version at location 1 on the web page, check the web pages that are displayed in the form of a pop-up window or the like and which are laid out for printout, and then print the desired web pages.

However, most of such printable versions of web pages are simply text that is laid out for printing, rather than providing all of the web-page information including images and the like. Additionally, such web pages that provide a printable version, even though simplified, are not universally provided.

Accordingly, a user will often edit and print the content of web pages by using a separate application program in order to prevent the content from being truncated when printed. Not only do such tasks result in user inconvenience, but also the editing steps are nearly impossible at some times since some application programs treat the images and text contained in the web page as one image block.

FIG. 2 is a view for illustrating an exemplary web-page printout displayed when the preview function is selected. In FIG. 2, the preview function enables a user to preview a web-page printout on a pop-up window before actually being printed on paper. The preview printout shows that the content of the web page will be truncated at the right side thereof when printed.

However, most printers do not provide a function for editing the preview printout under the preview function, so a user is often required to check the web-page printout through the preview function in advance, and then edit and print the web page by using a separate application program, which results in significant user inconvenience.

Accordingly, a need exists for a system and method to provide a web-page print method that prevents the content of a web page from being truncated off the paper when printed.

### SUMMARY OF THE INVENTION

The present invention has been developed in order to solve the above and other problems associated with the conventional arrangement and provide other additional advantages. An aspect of the present invention is to provide a web-page print method that prevents the content of a web page from being truncated off the paper when printed by adjusting and outputting the size of the web-page content according to the size of the paper.

The foregoing and other objects and advantages are substantially realized by providing a method for printing web pages comprising the steps of inputting a print command with respect to a certain web page, comparing a size of the web page to that of the paper, reducing text and images contained in the web page by a predetermined unit, respectively, if the size of the web page is larger than that of the paper, and generating data for printout with respect to the web page containing the reduced text and images and printing the data on the paper.

The comparison step can further comprise a step to compare the lengths of the web page and the paper in longitudinal directions.

The method can further comprise a step to check and confirm whether a need exists to resize the web page by notifying a user if the size of the web page is larger than that of the paper.

Further, the checking step can comprise a step to generate a pop-up window in order for the user to check and decide whether to resize the web page through the generated pop-up window.

The reduction step can comprise a step to separate the text from the images contained in the web page by using the HTML document with respect to the web page, and reduce the separated text and images by a predetermined unit, respectively.

Further, the text is preferably reduced based on predetermined font sizes.

Another aspect of the present invention is to provide a computer-readable medium providing commands for a host device having a processor that can be programmed to execute data-processing operations for an image-forming apparatus with print functions, wherein the operations comprise the steps of comparing a size of a web page to that of a paper if a print command to print the web page is input, reducing text and images contained in the web page by a predetermined unit if the size of the web page is larger than that of the paper, and generating data for printout with respect to the web page containing the reduced text and images and printing the data on the paper.

Accordingly, the present invention prevents the content of web pages from being truncated when printed on the paper.

### BRIEF DESCRIPTION OF THE DRAWINGS

The above aspects and features of the present invention will become more apparent by describing certain embodiments of the present invention with reference to the accompanying drawings, in which:

FIG. 1 and FIG. 2 are views for illustrating a conventional method for printing web pages;

FIG. 3 is a view for illustrating a system to which a method for printing web pages can be applied according to an embodiment of the present invention;

FIG. 4 is a view for illustrating a network printer system to which a method for printing web pages can be applied according to an embodiment of the present invention; and

FIG. 5 is a flow chart for illustrating a method for printing web pages according to an embodiment of the present invention.

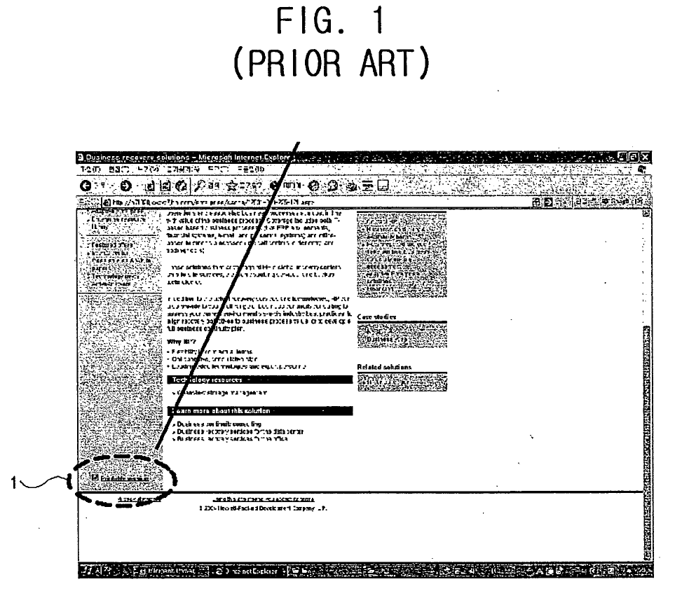

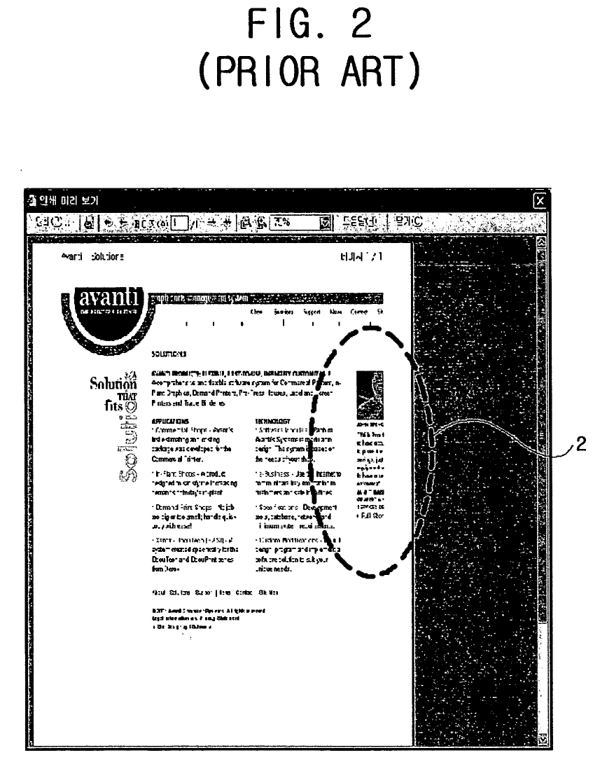

Throughout the drawings, like reference numerals will be understood to refer to like parts, components and structures.

### DETAILED DESCRIPTION OF THE EXEMPLARY EMBODIMENTS

Hereinafter, a number of exemplary embodiments of the present invention will be described in detail with reference to the accompanying drawings.

In the following description, same drawing reference numerals are used for the same elements even in different drawings. The matters defined in the description, such as detailed construction and element descriptions, are provided to assist in a comprehensive understanding of the invention. Also, functions or constructions well known to those skilled in the art are omitted for clarity and conciseness.

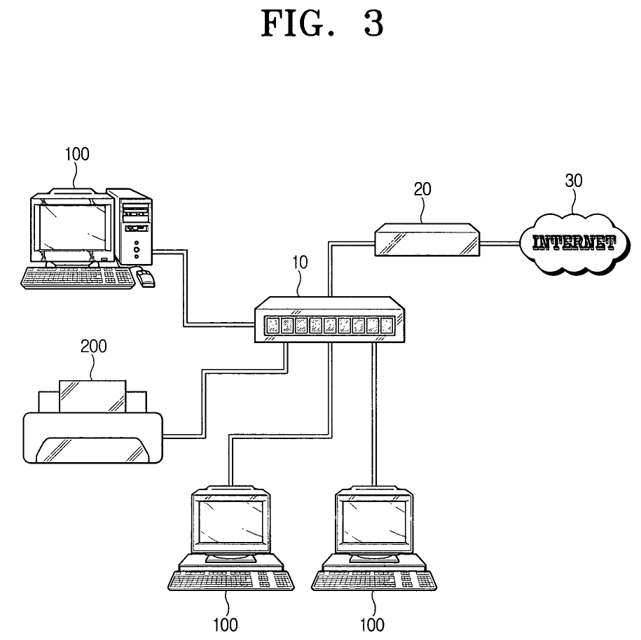

FIG. 3 is a view for illustrating a system to which a method for printing web pages according to an embodiment of the present invention can be applied. In the system of FIG. 3, a network-based printer 200 and a plurality of computers 100 are connected through a wireless or wired communication network to form a network-based system.

In FIG. 3, a plurality of computers 100 and a network-based printer 200 are connected to a hub 10 so as to form a network for mutual data communications. The hub 10 is connected to a router 20 for communications with an external network such as LAN or the internet 30. The router 20 reads a data destination address contained in a packet when transmitting and receiving data, and sends the packet to another communication network through the most suitable communication path.

Each computer 100 is connected to the internet 30 through the router 20 when a web browser such as Internet Explorer or Netscape is operating, and searches for information through web sites set up in the external networks connected to the internet 30. The web browser browses the searched web pages to enable a user to check each on a screen, and, if necessary, sends data through the hub 10 to the network-based printer 200 for printing.

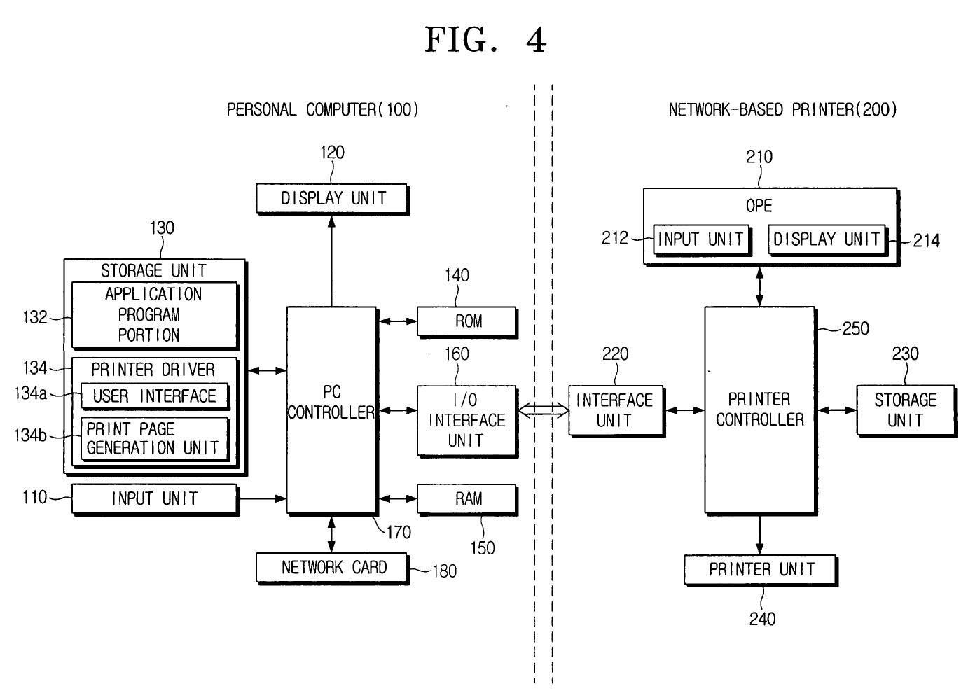

FIG. 4 is a view for illustrating a network-based printer system to which a method for printing web pages according to an embodiment of the present invention can be applied. Specifically, the view of FIG. 4 shows a schematic block diagram of the network-based printer 200 connected to a computer 100.

The computer 100 has an input unit 110, a display unit 120, a storage unit 130, a ROM 140, a RAM 150, an input/output (I/O) interface unit 160, a PC controller 170, and a network card 180.

The input unit 110 is generally comprised of a device such as a keyboard, mouse, and the like, and inputs user's commands. The display unit 120 is generally comprised of a monitor, which externally displays the operation status of the personal computer 100, as well as displays web pages browsed by a user through the internet.

The storage unit 130 is comprised of a printer driver 134 for interfacing an application program portion 132 for creating documents, with the network-based printer 200.

Further, the printer driver 134 comprises a user interface 134a for generating and displaying a print information setting window on the display unit 120 which reflects the user's configuration requirements for the network-based printer 200, wherein the print information setting window includes a configuration window and the like. Therefore, a user can operate the input unit 110 to input print options on the print information setting window, or select a web page resize print function for adjusting and outputting the content of a web page to fit the size of the paper.

Further, the printer driver 134 comprises a print page generation unit 134b, wherein the print page generation unit 134b adjusts the content of a browsed web page to the size of the paper using the web page resize print function selected through the user interface 134a in order to prepare data for printing, and sends the prepared data to the network-based printer 200 through the 1/O interface unit 160. The print page generation unit 134b is described in greater detail below.

The ROM 140 can be comprised of a nonvolatile memory device which stores various control programs necessary to implement the functions of the computer 100. Further, the RAM 150 can be comprised of a volatile memory device which temporarily stores data occurring during the performance of programs of the PC controller 170.

The I/O interface unit 160 is provided to be connected to the network-based printer 200, and carries out mutual data communications between the network-based printer 200 and the computer 100. In doing so, the I/O interface unit 160 sends the data prepared by the print page generation unit 134b to the network-based printer 200.

The PC controller 170 controls the overall operations of the personal computer 100 as a program stored in the ROM 140 is executed. The PC controller 170 is described in greater detail below.

The network card 180 connects the computer 100 to an external network such as a LAN, internet, or the like. In the example shown in FIG. 4, the network card 180 is separately installed, but in yet other embodiments of the present invention, the network card 180 can be incorporated into the I/O interface unit 160, or the functions of the network card 180 can be incorporated with the computer 100.

The network-based printer 200 is comprised of, in part, an operating panel (OPE) 210, an interface unit 220, a storage unit 230, a printer unit 240, and a printer controller 250.

The interface unit 220 is connected to the I/O interface unit 160 of the computer 100, and communicates data with the computer 100.

The OPE 210 is comprised of an input unit 212 and a display unit 214. The input unit 212 is comprised of a plurality of function keys for enabling a user to set various functions that are supported by the network-based printer 200, and the display unit 214 can be comprised of a display device such as LCD which displays the current operation status of the network-based printer 200.

The storage unit 230 stores various control programs necessary to perform the functions of the network-based printer 200, and further stores data occurring during the operations of the network-based printer 200, information on the data, and so on.

The printer unit 240 performs print jobs for data transmitted from the plurality of computers 100 on the network. The printer controller 250 controls the overall operations of the network-based printer 200.

In the above exemplary embodiment, the print page generation unit 134b is provided in the storage unit 130 of the computer 100, and performs the web page resize print function according to the operation of the exemplary embodiment of the present invention. However, the print page generation unit 134b can be provided as a software application in the storage unit 230 of the network-based printer 200 to perform the functions under the control of the printer controller 250 according to an embodiment of the present invention.

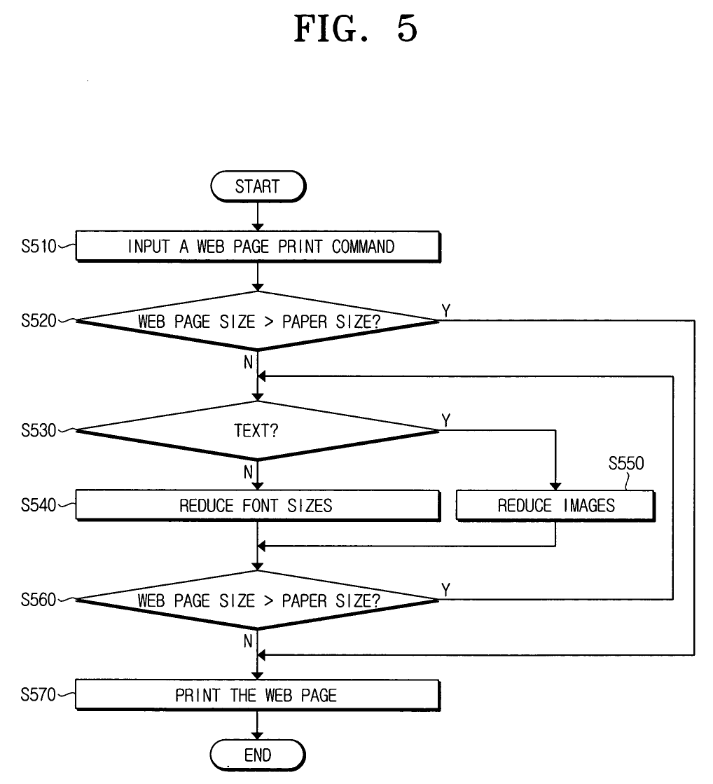

FIG. 5 is a flow chart for illustrating a method for printing web pages according to an embodiment of the present invention.

In the method of FIG. 5, a user can first turn on the computer 100, start a web browser to display search results on the display unit 120, and check a web page searched on the internet. The user can then input a print command for printing the searched web page through the input unit 110 at step (S510).

If the user inputs the print command for printing the searched web page through the input unit 110, the PC controller 170 controls the user interface 134a of the printer driver 134 to generate the print information setting window. Accordingly, the user can operate the input unit 110 to select the web page resize print function for adjusting the content of the web page through the print information setting window to fit the web page content to the size of the paper for printout, input configuration information for printing, or input other print options and the like.

If the web page print command is input, the PC controller 170 controls the print page generation unit 134b to compare the size of a web page for printout to the size of the paper at step (S520). In the comparison of the web page size with the paper size, it is preferable to compare the lengths of the web page and the paper, that is, the lengths of each in the longitudinal direction.

If the size of a web page for printout is larger than the size of the paper, the PC controller 170 can control the user interface 134a to generate a pop-up window asking if the user desires to select the web page resize print function.

The web page resize print function can be configured to generate the print information setting window whenever a print command is input, and to perform the functions of the generated print information setting window under the controls of the PC controller 170. Once a user selects the function, the same function can be performed whenever web pages are printed, unless the options are changed later.

If the web page for printout is larger in size than the paper, the PC controller 170 controls the print page generation unit 134b to distinguish the content of the web page for printout as text or images at step (S530). That is, the PC controller 170 separates the web page created in the general HTML document, that is, the content of the HTML document, into the text portions and the image portions.

Next, the PC controller 170 controls the print page generation unit 134b to reduce the font size, for example, by ‘1’, with respect to the text portions at step (S540), and to reduce the image sizes in proportion to a predetermined reduction ratio based on a unit indicating an image size with respect to the image portions at step (S550). The PC controller 170 then controls the print page generation unit 134b to generate data for printout with respect to the web page containing the reduced text and images.

The PC controller 170 then compares the size of the paper with the size of the web page containing the reduced text and images again at step (S560). If the web page is larger in size than the paper, the PC controller 170 returns to step (S530) and repeats the font size reduction step (S540) and the image size reduction step (S550) until the size of the web page becomes smaller than or equal to that of the paper.

Thus, once the size of the web page becomes smaller than or equal to that of the paper due to the text font size reduction and the image size reduction, the content of the web page can be fully printed on the paper without truncation. The PC controller 170 then controls the print page generation unit 134b to generate data for printout with respect to the reduced web page, send the data to the network-based printer 200 through the I/O interface unit 160, and print the data on the paper at step (S570).

As described above, embodiments of the present invention prevent the content of the web page from being truncated when printed by comparing the size of the web page to the size of the paper, and reducing the text font and image sizes of the web page by a predetermined unit, respectively, so that the web page fits onto the size of the paper.

Further, since the web page resize print method according to embodiments of the present invention can be implemented in a simple manner, users can avoid the inconvenience of separate edit and print jobs on the web page.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A method for printing web pages, comprising steps of:
inputting a print command with respect to a web page, wherein the web page comprises at least one of text data and image data;
comparing a size of the web page to that of a paper for printing;
reducing the text and images contained in the web page by predetermined units, respectively, if the size of the web page is larger than that of the paper; and
generating data for printout with respect to the web page containing the reduced text and images and printing the data on the paper.

2. The method as claimed in claim 1, wherein the comparison step comprises the step of:
comparing a length of the web page and a length of the paper in longitudinal directions.

3. The method as claimed in claim 1, further comprising a step of:
checking whether a user desires to resize the web page by notifying the user if the size of the web page is larger than that of the paper.

4. The method as claimed in claim 3, wherein the checking step comprises a step of:
generating a pop-up window in order for the user to check and decide whether to resize the web page through the generated pop-up window.

5. The method as claimed in claim 1, wherein the reduction step comprises the steps of:
separating the text from the images contained in the web page by using the HTML document with respect to the web page; and
reducing the separated text and images by predetermined units, respectively.

6. The method as claimed in claim 5, wherein the text is reduced based on predetermined font sizes.

7. A computer-readable medium providing commands for a host device having a processor to execute data-processing operations for an image-forming apparatus with print functions, comprising:
a first command for comparing a size of a web page to that of a paper for printing if a print command is input to print the web page, wherein the web page comprises at least one of text data and image data;
a second command for reducing the text and images contained in the web page by a predetermined unit if the size of the web page is larger than that of the paper; and
a third command for generating data for printout with respect to the web page containing the reduced text and images and printing the data on the paper.

8. The computer-readable medium as claimed in claim 7, wherein the first command compares a length of the web page and a length of the paper in longitudinal directions.

9. The computer-readable medium as claimed in claim 7, further comprising a fourth command for checking whether a user desires to resize the web page by notifying the user if the size of the web page is larger than that of the paper.

10. The computer-readable medium as claimed in claim 9, wherein the fourth command generates a pop-up window in order for the user to check and decide whether to resize the web page through the generated pop-up window.

11. An apparatus for printing web pages, comprising:
a display unit, for externally displaying a web page browsed by a user; and
a storage unit comprised of a printer driver for interfacing with a printer, wherein the storage unit is configured to generate and display printing information of the browsed web page on the display unit, adjust a browsed web page size to fit a size of a paper when printing, and output the adjusted browsed web page for printing.

12. An apparatus for printing web pages as claimed in claim 11, further comprising an input unit for inputting a user's commands.

13. An apparatus for printing web pages as claimed in claim 11, wherein the display unit is comprised of a monitor to externally display a web page browsed by a user.

14. An apparatus for printing web pages as claimed in claim 11, wherein the printer driver comprises:
a user interface for generating and displaying a print information setting window on the display unit regarding the browsed web page; and
a print page generation unit for adjusting the content of a browsed web page to fit the size of a paper when printing.
